(19) United States
(12) Patent Application Publication
(10) Pub. No.: US 2024/0076214 A1
(43) Pub. Date: Mar. 7, 2024

(54) Method of Protecting Oceans from Direct Sunlight and for Enhancing Alkalinity with Special Application to Protecting Coral Reefs

(71) Applicants: Bruce Johnson, Brookside (CA); Chris W. T. Johnson, Brookside (CA)

(72) Inventors: Bruce Johnson, Brookside (CA); Chris W. T. Johnson, Brookside (CA)

(73) Assignee: Coastal Bound Accessories, Brookside, NS (CA)

(21) Appl. No.: 18/239,796

(22) Filed: Aug. 30, 2023

Related U.S. Application Data
(60) Provisional application No. 63/403,332, filed on Sep. 2, 2022.

(51) Int. Cl. C02F 1/68; C02F 1/66

(52) U.S. Cl. CPC C02F 1/68; C02F 1/66; C02F 2103/08; C02F 2301/043

(57) ABSTRACT

Method for reducing ocean temperatures and enhancing alkalinity, the method cited here both reduces ocean acidification and helps lower ocean water temperature by reflecting the sun with a froth flotation of bubbles, a method when used in areas of coral reef improves the conditions necessary for coral reef growth, the method consists of first locating a dispersing source, such as a boat or other device able to position itself over a coral reef, or in any ocean section, second creating a froth flotation of bubbles with alkaline and other minerals attached, and then third dispersing the froth flotation consisting of bubbles with minerals attached, over the coral reefs, and then having the bubbles to reflect the sun rays to lower ocean temperature, the method also allows the alkaline minerals to disengage from the bubbles over time, reducing the acidification levels in the ocean and around coral reefs.

### FIELD OF INVENTION

This invention relates to the field of froth flotation, attaching neutralizing minerals and other minerals to bubbles to create froth, and to disbursing that froth over ocean areas of interest and especially coral reefs so that the minerals can be released over time while at the same time increasing the albedo of the sea surface to reduce warming of surface seawater.

### BACKGROUND

This invention is in the area of climate change mitigation and particularly focuses on countering the principal threats of climate change to the oceans, which include warming of surface waters and acidification. Warming of the oceans causes decline in relatively stenothermic species such as corals, inhibits mixing of nutrients from deep waters into the euphotic zone, causes melting of polar ice which results in sea level rise, threatens deep water formation and provides energy for catastrophic storms. The other major threat to oceans is acidification which reduces the capacity of the surface ocean to absorb atmospheric CO2, and at the same time causes a decline in concentration of carbonate ion, a necessary component of the hard parts of corals, shellfish and other marine organisms.

It has become increasingly clear in recent years that we will not meet our commitments to limit the production of greenhouse gases through reducing fossil fuel burning and that our current course will not be sufficient to keep global temperatures from rising 1.5 degrees C. Geo-engineering solutions that limit solar insolation may reduce global warming, but they do not address CO2 build-up in the atmosphere, nor a principal consequence of this build-up, ocean acidification. Cooling the planet without addressing the problem of ocean acidification will undoubtedly open the door to more fossil fuel burning.

The imperative of addressing CO2 build-up in the atmosphere in addition to addressing global warming is clear when considering how rapidly the atmospheric concentration is changing. On the very first Earth Day in 1970, CO2 in the atmosphere had reached 325 ppm. In 2023 the concentration has increased by nearly 30% to approximately 420 ppm. Modeling suggests that we will reach 1.5 centigrade degrees of warming, as early as a concentration of 425 ppm, although this is at the lower end of a range of uncertainty that reflects our poor understanding of climate sensitivity. Retrieved from UK Met Office database, Aug. 19, 2023 How much CO2 at 1.5° C. and 2° C.?—Met Office.

Failure to reduce CO2 emissions on a global scale has forced us to consider means of directly removing CO2 from the atmosphere and storing it for long time periods in geological, biological or ocean reservoirs. Known collectively as “carbon dioxide removal” or CDR, these technologies are still in their infancy.

One proposed CDR involves treating seawater with alkalinity enhancing minerals, a strategy that causes a shift in carbonate equilibria that increases the buffer capacity of seawater and thereby increases its capacity for atmospheric CO2 uptake. The advantages of this CDR go beyond increasing the storage capacity for CO2, since the resulting shift in carbonate system equilibria increases the concentration of CO₃²⁻ ion which enhances saturation of calcium carbonate and thereby facilitates hard part formation by corals, shellfish and other organisms such as pteropods.

Note: Alkalinity is the number of moles of hydrogen ion, equivalent to the excess of proton acceptors over proton donors

While adding alkalinity enhancing minerals to seawater offers a promising means of reducing CO2 in the atmosphere, there are a number of problems to be overcome before the potential of this method can be realized (National Academies of Sciences, retrieved Aug. 19, 2023: https://doi.org/10.17226/26278

Addition of alkaline mine tailings has the potential to introduce heavy metals or other toxins that may be amplified through the food chain. Also, how to introduce alkaline particles to the ocean is problematic. Compression of the surface electrical double layer of particles in seawater means that even micron sized alkaline particles may aggregate with other particles and sink out of the ocean surface layer before they can fully react. Similarly, particles in seawater are known to acquire adsorbed organic coatings and biofilms that may reduce surface reaction rates, which again may contribute to sinking out of the surface layer before reaction. What is more, if reaction time is indeed a limiting factor, introducing particles in coastal areas at the bottom or on beaches may solve the problem of particle sinking, but would at the same time threaten these highly sensitive ocean ecosystems.

The oceans are known to take up about 20% of the annual production of fossil fuel CO2, but the capacity for uptake is declining as the buffer capacity of seawater decreases. Also, the world's oceans are heating up. Scientists have found that 2018 was the hottest year ever recorded for our oceans, and that they are warming even faster than previously thought. When documenting global warming trends, we often focus on air temperature. But the oceans actually absorb more than 90 percent of the excess heat trapped by human emissions of greenhouse gases. Published Feb. 22, 2010 in Climate Magazine.

For eons, the world's oceans have been sucking carbon dioxide out of the atmosphere and releasing it again in a steady inhale and exhale. The ocean takes up carbon dioxide through photosynthesis by plant-like organisms (phytoplankton), as well as by simple chemistry: carbon dioxide dissolves in water and more so in colder water. It also reacts with seawater, creating carbonic acid. Carbonic acid releases hydrogen ions, which combine with carbonate in seawater to form bicarbonate, a form of carbon that doesn't escape the ocean directly by gas exchange nor is it available for corals, shellfish and other organisms that produce calcium carbonate hard parts.

As we burn fossil fuels and atmospheric carbon dioxide levels go up, the ocean absorbs more carbon dioxide to stay in balance. But this absorption has a price: these reactions lower the water's pH, meaning it's more acidic. And the ocean has its limits. As temperatures rise, carbon dioxide leaks out of the ocean because it is less soluble in warmer water, “like a glass of root beer going flat on a warm day”, and as more CO2 is absorbed, the pool of carbonate ions decreases as does the capacity for more CO2 uptake. The Ocean's Carbon Balance (nasa.gov)

Technologies that increase the capacity for ocean uptake of atmospheric CO2 provide very promising potential for CDR. There are many such proposed technologies of which alkalinity enhancement may have the most potential. The method being presented here involves creating a froth flotation of bubbles to reflect the sunlight, and also attaching to the bubbles certain alkaline minerals, i.e., basic minerals, and perhaps mine tailings, to treat seawater to increase the capacity for CO2 uptake.

Status of Coral Reefs

Coral reefs occupy less than 1% of the ocean floor, but are home to more than 25% of marine life (Coral Reef Alliance). In addition to being among the most species diverse regions on the planet, coral reefs offer substantial economic benefits through protecting shorelines from waves and storm surges, through providing habitat for many animals in a range of lifecycle stages and through supporting food production and tourism. Despite the importance of coral reefs, they are under severe threat from climate change.

Two problems associated with the burning of fossil fuels threaten ocean corals. First, the addition of anthropogenic CO2 to the atmosphere along with associated positive feedback mechanisms, are causing a warming of the atmosphere and oceans. Due to a relatively narrow tolerance in temperature range for the algae that are in symbiosis with corals, rising ocean temperatures are severely damaging reefs through a process called “bleaching”. Second, uptake of anthropogenic CO2 by the oceans through dissolution in seawater is causing ocean acidification which results in a shift in chemical equilibria away from carbonate ion, CO₃²⁻. This loss of carbonate ion acts to inhibit precipitation of calcium carbonate hard parts by corals, shellfish and some other marine organisms such as pteropods.

The surface ocean nearly everywhere is saturated in calcium carbonate. An expression of this saturation is Ω_{arg}, the product of [Ca⁺²] and [CO₃²⁻] divided by the solubility product constant for aragonite (Ksp_{arg}). This parameter has been decreasing in the surface ocean because of CO2 uptake, and in those areas where it has fallen below 3, the water chemistry has become “extremely marginal” for coral growth, as demonstrated by the absence of prominent coral reef ecosystems Future coral reef habitat marginality: Temporal and spatial effects of climate change in the Pacific basin. Guinnotte, John M, Buddemeier, R. W., Kleypas, Future coral reef habitat marginality: Temporal and spatial effects of climate change in the Pacific basin 2003, (PDF) Future coral reef habitat marginality: Temporal and spatial effects of climate change in the Pacific basin (researchgate.net)

It is important to note that while coral reefs provide exceptional benefits in marine productivity, diversity and human economic welfare, precipitation of calcium carbonate to form the reef structure actually produces CO2 that increases the concentration of this greenhouse gas in the atmosphere. Thus, alkalinity enhancement seems particularly appropriate for these ecosystems.

Various methods have been proposed for protecting coral habitat. For example, experiments are underway to counter coral bleaching by producing cloud cover above a reef in order to reduce solar heating of surface waters (Latham, et al., 2012. Marine cloud brightening. Roy. Soc. A., 370, 4217). This is being done by injecting seawater droplets into the atmosphere, droplets that evaporate to produce hygroscopic aerosol particles that then act as cloud condensation nuclei. The resulting clouds reflect light back to space and thus reduce heating of the surface seawater. While the method appears sound, there are concerns about predictability of cloud trajectories, as well as, effects of the clouds and the aerosol on surrounding coastal areas. Russel Seitz (Seitz, Bright water: hydrosols, water conservation and climate change. Climatic Change, 105(3-4), pp. 365 2011), has suggested using natural stable microbubbles to reflect light from the surface ocean. These ideas for reducing surface ocean warming use natural processes to increase albedo. Following their lead, we have extended the idea of harnessing a natural process, here foam formation, to increase albedo, but also to counter acidification.

The method cited in this application is for reducing ocean temperatures and enhancing alkalinity, which counters problems that result from climate change, and are problems especially harmful to coral reefs. Ocean acidification threatens coral reef futures by reducing the concentration of carbonate ions that corals need to construct their skeletons, the method cited here both reduces ocean acidification and helps lower ocean water temperature by reflecting the sun with a froth flotation of bubbles, a method when used in areas of coral reefs improves the conditions necessary for coral reef growth.

Key Elements of the Invention

This method counters both threats to the ocean's ability to absorb CO2 and threats to coral reefs. The method involves production of particle stabilized foams, which consist of bubbles with minerals attached to the bubbles, that shade the underlying water and at the same time transport alkaline particles that are then released and widely distributed over space and time as the foams collapse naturally to counter ocean acidification.

Particle stabilized foams are well known in the mining industry where they are used to separate minerals in froth flotation. An embodiment of the proposed method that we have now studied on the bench top involves the use of calcium carbonate and calcium hydroxide particles in seawater (note: calcium oxide reacts with water to form calcium hydroxide) with addition of a very low concentration of dissolved sodium oleate as the collector, i.e., the substance that adsorbs to the particle surfaces and promotes attachment to bubbles.

Calcium carbonate particles comprise the sand in many regions where coral reefs are present. In the simplest embodiment these sand particles are treated with sodium oleate, and then agitated with seawater to generate a stable reflective foam. However, calcium carbonate particles do not typically dissolve to enhance alkalinity in ocean regions inhabited by coral reefs, but are effective where the seawater is particularly corrosive such as in upwelling regions. However, to counter acidification and increase CO2 uptake, calcium oxide particles, which tend to be micron sized, can be used or mixed with calcium carbonate to provide structure, and thereby enhance alkalinity both in targeted ocean sections and over coral reefs.

The advantage of identifying both calcium oxide and calcium carbonate as particles suitable for producing particle stabilized foams using sodium oleate as a collector is that a mixture of the two minerals can be used to meet the requirements for shade or alkalinity enhancement according to the specific need of the ecosystem.

From the applicant's studies they have learned how to produce the key steps in this method:
stabilized foams of bubbles with minerals attached—both calcium carbonate and calcium oxide, and mixtures of the two, can be treated with sodium oleate and then through agitation in seawater produce particle stabilized foams.
Reduce the heating of the ocean in target sections and by coral reefs—particle stabilized foams are reflective, returning light to space. Consequently, these foams reduce heating of underlying waters.
Releasing the alkaline particles—where alkaline particles are incorporated in foams, collapse of the foams releases alkalinity enhancing particles to the water column.
Time release of the alkaline particles—the collapse of particle laden foams releases particles more widely over space and time, resulting in less environmental damage than if the particles are introduced as a slurry.
Time release of the alkaline particles—in more quiescent conditions particle stabilized foams can remain stable for weeks on the water surface.
Surfactants used to promote attachment of particles to bubbles—we have studied sodium oleate as a stabilizer, the surfactant that promotes attachment of the particles to bubbles. Sodium oleate is the sodium salt of oleic acid which is the most common fatty acid in nature, is non-toxic, non-bioaccumulating and is biologically labile. As such it breaks down relatively quickly in the natural environment promoting foam collapse and release of particles.

While the above is focused on rehabilitating coral reef habitat, the method for introducing alkalinity enhancing minerals to the ocean is more generally applicable to target ocean sections and offers a way to reflect light back into space while introducing the particles to counter ocean acidification.

The applicants have demonstrated various methods to produce particle stabilized foams, and have devised other methods still to be tested. Some of these methods include:
Dissolving the sodium oleate in warm distilled water and then mixing this solution, particles and seawater together through vigorous shaking.
Combining ingredients in a blender and mixing.
*Combining ingredients ahead of the impeller of a centrifugal pump where gas can be introduced and the amount of mixing can be controlled by a bypass valve
*Pumping the gas and the particle slurry through a nozzle
*Combining ingredients, and then pumping them into the prop of a boat where entrainment of air produces bubbles. The prop then mixes this air with the particles and sodium oleate solution. Prop mixing also disperses the foam over a wider area behind the boat.
*Any of the first three above to produce the foam that can be pumped directly on the water surface or into the prop of a boat to facilitate dispersion *methods yet to be tested

### SUMMARY OF THE INVENTION

The invention disclosed builds on areas of endeavor that include mineral flotation, bubble and foam stabilization by particles, and seawater alkalinity enhancement. In particular, the method devised whereby foams that carry alkaline particles and assemblages of alkaline particles reflect incident radiation back to space and at the same time transport and distribute widely, alkalinity enhancing materials to seawater.

In practice, the method of this application, as it would apply to a coral reef, consists of first locating a dispersing source, such as a boat or other device able to position itself over a coral reef, or in any ocean section, second creating a froth flotation of bubbles with alkaline and other minerals attached, and then third dispersing the froth flotation consisting of bubbles with minerals attached, over the coral reefs, and then using the bubbles to reflect the sun rays to lower ocean temperature and allow the alkaline minerals to disengage from the bubbles over time, reducing the acidification levels in the ocean and around coral reefs. This method is particularly effective when the froth flotation is in place over a coral reef when the sun is approaching, and at its highest point. Froth flotation is also effective when it is released upwind or on a rising tide where it is in an ocean area of interest and allowed to float over the area of interest such as a coral reef. Regular treatment of coral reefs with alkalinity enhancing minerals may, over time, lead to a build-up of certain minerals, e.g., magnesium oxide, in the sediments that will work to counter acidification in the vicinity of the reefs. The high value of reefs both economically and ecologically makes such treatments of reefs viable.

Mineral flotation, broadly employed for separations in the mining industry, pairs minerals and mineral-specific collectors, typically surface-active organics that attach to the mineral surfaces, and also attach to bubbles for transport to the air-water interface creating a mineral rich froth (FIG. 1). Many collector/mineral combinations have been identified and studied, as have the methods for producing the bubble froths. Bubbles that comprise these froths or foams may typically have fairly sparse coatings of particles or may be densely packed in which case particle stabilized bubbles may result. Bruce D. Johnson and Peter J. Wangersky 1987; Microbubbles: stabilization by monolayers of adsorbed particles. J. Geophys. Res., 92, 14,641). The advantage of particle stabilization lies in potential foam longevity, as particle stabilized foams in labs operated by Bruce D Johnson have remained virtually unchanged for a year. Note that “foam” includes patch sizes ranging from full areal coverage to micro scale, i.e., less than 0.5 mm.

This invention may be especially effective in protecting valuable and highly sensitive regions of the oceans such as coral reefs, but application of foams for the dual purposes of increasing ocean surface albedo and distributing alkalinity enhancing minerals has broad possibilities. Typical foams produced using collectors such as sodium oleate are somewhat fragile, break apart in turbulence, and then sink. In broader application, there is the potential for developing foams with non-toxic and water-soluble binders that prolong the life of the foam. Beyond this in terms of residence time at the surface, metal oxide foams, including aerogels (Yunsheng Wang, Yuantao Chen, Chen Liu and Fang Yu. Preparation of Porous Magnesium Oxide Foam and Study on its Enrichment of Uranium. Journal of Nuclear Materials, 2018), can be engineered for large surface contact areas and also to float on the water surface until they have fully reacted. Another strategy for maximizing the impact of alkaline particle laden foams is to introduce them on the sea surface in relatively quiescent areas such as the Inter-tropical Convergence Zone or ITCZ. This is an ocean region that appears to have a significant impact on hurricane formation.

The albedo of the surface ocean averages 0.05 to 0.10 (Seitz, R., 2011. Bright water: hydrosols, water conservation and climate change. Climatic Change, 105(3-4), pp. 365), which can be compared to total reflection of light which by definition is an albedo of 1.0. Thus, incident light on the ocean surface results in by far the greater fraction being absorbed as heat with only a small fraction returned to space. In one embodiment of this proposed method the applicants generated foams composed of a non-toxic organic collector, sodium oleate, and small particles of alkalinity enhancing materials, e.g., calcium carbonate, calcium hydroxide, magnesium hydroxide, etc. In a determination of albedo of the foam mixture, we adapted the method developed by Katheleen Gorski of the Albedo Project (K. M. Gorski, 2018. The Albedo Project; as described in:

Measuring Albedo; scholarworks.umass.edu. https://scholarworks.umass.edu/cgi/viewcontent.cgi?filename=2&article=1009&context=:stem_ipy&type=additional

In this method a piece of A4 bond is used as a reference against the surface for which albedo is being measured. A digital photograph (imageJ; 2011, http://rsbweb.nih.gov/ij/)

provides the input to an image analysis program, ImageJ. The relative reflectance of the background is then determined compared to the paper.

In the applicants measurements of albedo a rigid divider was placed across the middle of a 9 liter tank. In preparation for a measurement, the bottom of one side of the tank was covered with a layer of ½″ granite stone to provide a relatively non-reflective background for the foam layer. A blank was measured by comparing the reflectance of the gravel side of the water filled tank to the white paper. The albedo was measured to be 0.11 which is close to the 0.05 to 0.1 reported by Seitz for ocean albedo. In analysis of results the albedo of the paper was taken to be 0.65 as has been reported (Gilchrist, Gorski, 2011, National Printing Company, 2011). After measuring the albedo of the background gravel side, the applicants added a ¼″ layer of foam produced by agitation of 0.25 g of sodium oleate, 1 liter of seawater and 8 grams of 0.5 mm calcium carbonate particles. The foam was then collected, transferred to the gravel side of the tank, and measured. The albedo was found to be 0.55 which is about 85% of the albedo of the bond paper and about 5 times more than the albedo of the gravel background. An albedo of 0.55 can be compared to albedos of 0.05-0.18 for forests, 0.22-0.28 for grasslands and 0.15-0.26 for crops. Only the albedo of snow at 0.75-0.95 exceeds that of the measured albedo of the foam.

In the applicants measurements of albedo, they found albedos for calcium oxide and magnesium oxide foams and foams with no alkalinity enhancing particles to be indistinguishable from the albedo of the foam containing calcium carbonate described here. In addition, foams with darker particles incorporated in foams also showed increases in albedo relative to suspensions of the particles without foam. Note also that foams produced by agitating sodium oleate in seawater without alkalinity enhancing particles provides an effective means of reflecting light back to space in instances where alkalinity enhancement is not a priority.

In addition to measuring albedo of the applicants particle foams, they have conducted laboratory experiments to gain some insights into the effects of calcium hydroxide foams on CO2 uptake.

In one experiment a foam was generated by mixing 0.25 g of sodium oleate, 0.1 g of sodium silicate and 4 g of calcium oxide (approximately 5 microns particle size) in 250 ml of 35 ppt artificial seawater. The most effective foam generation method that the applicants found involves using a Braun Multi Quick 5V with the mixing vessel being a Bernardin 750 ml wide mouth mason jar. The details appear to be important (FIG. 2), as mixing to produce foams introduces turbulence that causes a steady state of foam production and foam destruction. In producing foams the applicants employed 20 seconds of high speed mixing consisting of intervals of 3 seconds of mixing followed by lifting the mixer out of the vessel to trap air in the mixer head, followed by more mixing as the head is returned to the bottom of the vessel.

Typically, a thick foam was produced with no visible particles remaining in the bottom of the mixing chamber (FIG. 3). Note that the addition of sodium silicate results in a substantially higher efficiency of particle inclusion in the foam (Da Yong Sun, Wan Zong Yin, De Shan Zu, Ming Bao Liu and Xi Mei Luo, 2012, Flotation Characteristics of Brucite and Serpentine, AMR, 454, 199 2012).

The foams containing alkalinity enhancing minerals collapse over time in low turbulence environments, and more rapidly when turbulence is present, releasing the particles to settle through the water column. Often, particles and bubble particle aggregates are seen to erode from the bottom of foams. The inclusion of bubbles causes these assemblages to remain suspended above the bottom, extending the residence times of the particles in the water column. One question that the applicants have addressed in their experiments is, while the foam is intact, can the upper surface of the foam in contact with the atmosphere directly absorb CO2 from the air. Evidence suggests that such absorption might be limited by the small volume of fluid associated with foams. For example, CO2 absorption in a foam of a sodium carbonate-bicarbonate buffer solution was found to be limited by CO2 saturation of the film (David C. Perry and Paul Stevenson, 2015, Gas Absorption and Reaction in a Wet Pneumatic Foam, Chemical Engineering Science, 126, 177). To answer this question, calcium oxide foam prepared as previously described was added to the surface of a 250 cc seawater sample in an air-tight container. The top for the container had a gas-tight bulkhead tubing connector with tubing attached that led to a tee which in turn was connected, one arm to a pressure sensor and the other to a valve leading to a 25 cc syringe (FIG. 4).

Injection of 25 cc of CO2 at atmospheric pressure into the vessel resulted in a pressure rise of 40 mb, this pressure spike immediately began to decay until after 35 minutes it again reached atmospheric. The shape of the curve was consistent with exponential decay with a time constant of about 7 minutes. In contrast, when air was injected instead of CO2 there was no decay in pressure even after several hours. Repeated injections of CO2 showed a slowing of the reaction rate, and calculations then showed that the reaction was limited to the foam surface in contact with the air. Thus, thin foams and reworking by wind and waves to expose more of the foam surface would seem to benefit direct CO2 uptake. These results add one more to the advantages of using particle transporting foams as a strategy in combating the problems of CO2 buildup in the atmosphere and its effects on the oceans.

These advantages include:
Particle foams and foams without particles increase the albedo of the ocean surface resulting in substantially greater return of electromagnetic energy back to space.
Foams can transport alkalinity enhancing particles for deposit over greater distances and broader areas compared to particles introduced in slurries, thereby reducing the potential for local environmental damage.
Small particles aggregate in seawater which means that releasing them from foams over time and distance reduces particle-particle contacts keeping them in the ocean surface layer for longer periods to allow more complete dissolution
While particle foams dissolve and enhance alkalinity from interaction with seawater on the underside, the upper surface of the foam reacts directly with CO2 in the atmosphere.
Alkaline particles such as magnesium oxide (hydroxide) have very low solubility and consequently may sink out of the surface layer without dissolving completely. Robust foams engineered either through use of water soluble binders or optimized for surface area and buoyancy using methods employed in metal oxide foam production can increase foam residence times at the air-seawater interface to days and even months.

The applicants used calcium oxide (also known as quicklime) in the above experiments because it is a potential compound for use in alkalinity enhancement. They also considered that, as a source of calcium ion, it supplies one of the determinants of the magnitude of Ω_{arg} which is a measure of the state of saturation of calcium carbonate minerals. That said, there are important cautions in that addition of calcium can cause “runaway” calcium carbonate precipitation (Moras et al. 2022), where calcium carbonate precipitation actually produces CO2, and in a runaway state can negate alkalinity enhancement. In addition, calcium hydroxide is caustic, and probably not a material that should be ingested by organisms. A better choice appears to be magnesium hydroxide (brucite), known medicinally as milk of magnesia. Magnesium hydroxide is considerably less soluble than calcium hydroxide, and consequently, where magnesium ions are present as in seawater, dissolution of calcium hydroxide can locally result in precipitation of magnesium hydroxide. This is not a problem since magnesium hydroxide dissolves over a longer time period, but enhances alkalinity and does not share some of the problems of the more caustic calcium hydroxide. Finally, since calcium carbonate is saturated nearly everywhere in the surface oceans, its use for alkalinity enhancement has been proposed only for upwelling regions where seawater is more corrosive.

Method Steps of the Inventions
1. Locating a dispersing source over a coral reef or target ocean section.
2. Creating a froth flotation of bubbles with alkaline minerals attached:
   a. Creating bubbles in seawater through a mixing action, possibly shaking, using a blending apparatus, using a centrifugal pump with a bypass valve, or mixing with the prop of a boat;
   b. Adding surfactant to the air/bubble combination, using any number of mixing techniques mixing in sodium oleate, or another non-toxic surfactant to attach to the bubble surface in the air bubble mixture creating a froth mixture;
   c. Introducing alkaline particles to a froth mixture so the alkaline particles can attach to the bubbles.
   d. All three steps may be combined, creating bubbles in a mixture already including sodium oleate and alkaline materials.
   e. Dispersing the froth mixture over the targeted ocean section or coral reef by a method such as dispersing the froth mixture with the propeller of the boat.

Advantages include:
Particle foams and foams without particles increase the albedo of the ocean surface resulting in substantially greater return of electromagnetic energy back to space.
Foams can transport alkalinity enhancing particles for deposit over greater distances and broader areas, reducing potential for local environmental damage.
Small particles aggregate in seawater which means that releasing them from foams over time and distance reduces particle-particle contacts keeping them in the ocean surface layer for longer periods to allow more complete dissolution
While particle foams dissolve and enhance alkalinity from interaction with seawater on the underside, the upper surface of the foam reacts directly with CO2 in the atmosphere.
Alkaline particles such as magnesium oxide (hydroxide) have very low solubility and consequently may sink out of the surface layer without dissolving completely. Robust foams engineered either through use of water soluble binders or optimized for surface area and buoyancy using methods employed in metal oxide foam production can increase foam residence times at the air-seawater interface to days and even months. Residence times at the air-water interface can also be increased by releasing foams at the surface in very low turbulence regions such as the Intertropical Convergence Zone or ITCZ.

Benefit of the Invention for Coral Reefs

This method is particularly effective when the froth flotation is in place when the sun is approaching, or at its highest point. Froth flotation is also effective when it is released upwind or on a rising tide where it is in an ocean area of interest and allowed to float over the area of interest such as coral reef.

Other Applications

Application of foams for the dual purposes of increasing ocean surface albedo and distributing alkalinity enhancing minerals has broad possibilities. Typical foams produced using collectors such as sodium oleate are somewhat fragile, break apart in turbulence, and then sink. In broader application, there is the potential for developing foams with non-toxic and water-soluble binders that prolong the life of the foam. Beyond this in terms of residence time at the surface, metal oxide foams, including aerogels (Yunsheng Wang, Yuantao Chen, Chen Liu and Fang Yu. Preparation of Porous Magnesium Oxide Foam and Study on its Enrichment of Uranium. Journal of Nuclear Materials, 2018), can be engineered for large particle surface contact areas and also to float on the water surface until they have fully reacted. Finally, introducing particle carrying foams in the inter-tropical convergence zone provides a very low turbulence environment where the scattering of light back to space and distributed release of alkalinity enhancing particles can be fully exploited.

### BRIEF DESCRIPTION IF DRAWINGS

FIG. 1: Cross section of dried foam patch (0.5 cm diameter) showing intact bubbles, as well as, edges of bubbles with adsorbed calcium carbonate particles

FIG. 2: Arrangement for producing high yield foams with alkaline particles.

FIG. 3: Mason jar containing a layer of calcium hydroxide foam on 250 ml of 35 ppt (parts per thousand) seawater.

FIG. 4: Arrangement for injecting carbon dioxide gas into vessel containing calcium hydroxide foam

### DESCRIPTION OF NUMBERS IN DRAWINGS

1. mixing motor for Braun Multi Quick 5 v hand mixer
2. bell head containing mixing blade and within which air is trapped
3. mixing vessel: wide mouth 750 ml Bernardin mason jar
4. produced foam
5. seawater
6. pressure sensor
7. tee
8. valve
9. 25 cc syringe
10. air-tight gas fitting
11. gas space above foam
12. calcium hydroxide foam
13. 250 ml of 35 ppt seawater

### DETAILED DESCRIPTION

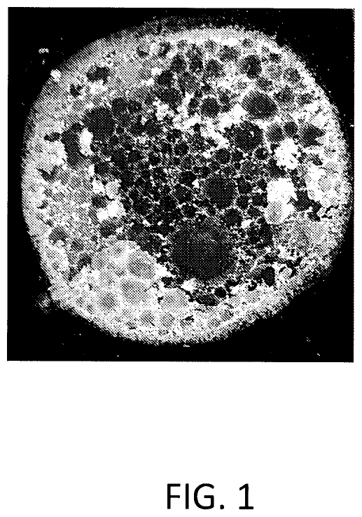

FIG. 1 shows a cross section of dried foam patch (0.5 cm diameter) showing some intact bubbles, as well as, edges of bubbles with adsorbed calcium carbonate particles demonstrating a mineral rich froth, pairing minerals and mineral-specific collectors, typically surface-active organics that attach to the mineral surfaces, and also attach to bubbles for transport to the air-water interface creating a mineral rich froth

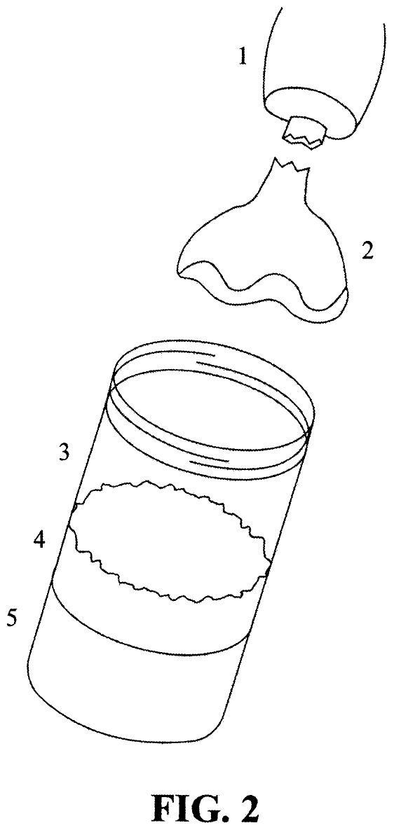

FIG. 2 is a lab version of how to produce high yield foams with alkaline particles, a mixing motor or hand mixer 1 is used, an impeller is contained in a bell head 2 within which air is trapped, containment is done in a mixing vessel, 3 in the photo a 750 ml Berardin mason jar, which contains the foam 4 and seawater 5.

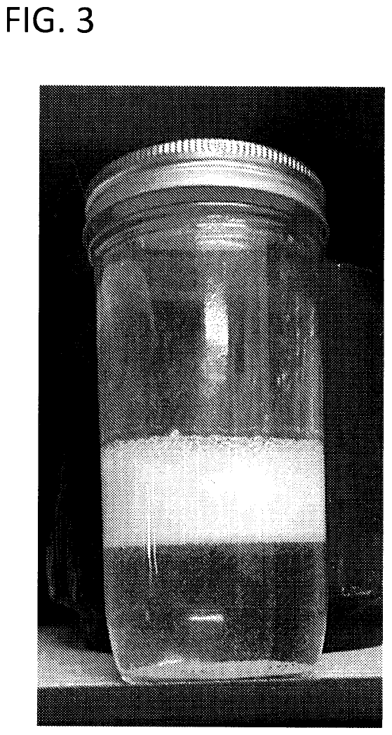

FIG. 3 shows a typical layer of calcium hydroxide foam produced from a slurry of 250 ml of seawater, 0.25 g of sodium oleate, 4 g of calcium oxide and 0.1 g of sodium silicate mixed to form a foam sitting above seawater in a container.

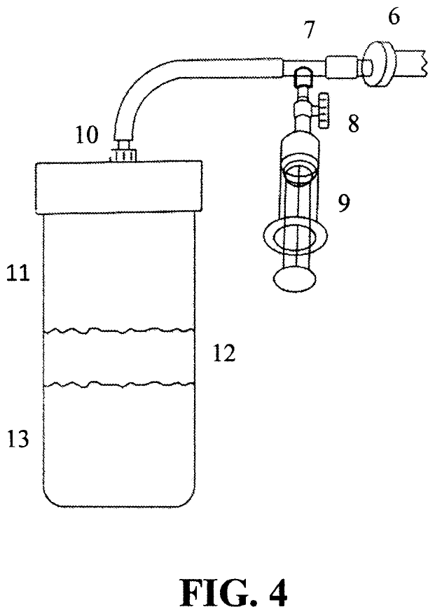

FIG. 4 is a lab version showing how to inject carbon dioxide gas into vessel containing calcium hydroxide foam, the key components are:

a pressure sensor 6 that measures the pressure of the gas, a tee into the airline for combining CO2 with air, 7 and a valve 8 that release the CO2 from the syringe 9, the air CO2 mixture entering the container through an air-tight gas fitting 10, the container having gas space above the foam, 11, 250 ml of 35 ppt of seawater 13 on the bottom of the container and calcium hydroxide foam 12 above the seawater.

We claim:

1. Method for reducing ocean temperatures and enhancing alkalinity, the method cited here both reduces ocean acidification and helps lower ocean surface water temperature by reflecting the sun with a froth flotation of bubbles comprising:
locating a dispersing source over a coral reef or target ocean section;
creating bubbles in water through a mixing action;
pairing minerals and mineral-specific collectors, typically surface-active organics, that attach to the mineral surfaces, and to bubbles for transport to the air-water interface;
dispersing the froth mixture of bubbles with alkaline materials attached over the targeted ocean section or coral reef.

2. The method of claim 1 where the dispensing source is a boat or boat variation, platform, airplane.

3. The method of claim 1 where bubbles are created by shaking, using a blending apparatus, using a centrifugal pump with a bypass valve, or mixing with the prop of a boat;

4. The method of claim 1, using any number of mixing techniques, including shaking, using a blender apparatus, using a centrifugal pump with a bypass valve or with the prop of a boat to mix in sodium oleate, or another surfactant to attach to the bubble surface in the air bubble mixture creating a froth mixture;

5. The method of claim 1 where all three steps may be combined, creating bubbles in a mixture already including sodium oleate, or other surfactants and alkaline materials.

6. The method of claim 1 where two of the three steps are combines, creating bubbles in a mixture including sodium oleate or other surfactants, or creating bubbles in a mixture including alkaline materials.

7. The method of claim 1 which dissolves the sodium oleate or other surfactant in warm distilled water and then mixing this solution, particles and seawater together through vigorous shaking or other mixing technique.

8. The method of claim 4 where ingredients ahead of the impeller of a centrifugal pump where gas can be introduced and the amount of mixing can be controlled by a bypass valve.

9. The method of claim 1 where gas and a slurry of sodium oleate or other surfactant and alkaline materials are sent through a nozzle to create a froth of bubbles.

10. The method of claim 1 where ingredients are combined and then pumped into the prop of a boat where air is injected to produce bubbles. The prop then mixes this air with the particles and sodium oleate or other solution and alkaline materials whereby prop mixing disperses the foam over a wider area behind the boat.

11. The method of claim 1 where all methods of producing froth of bubbles can be pumped directly on the water surface or into the prop of a boat to facilitate dispersion
